(19) United States
(12) Patent Application Publication
(10) Pub. No.: US 2009/0289100 A1
(43) Pub. Date: Nov. 26, 2009

(54) Method and apparatus for rework soldering

(75) Inventors: Tetsuji Ishikawa, Kawasaki (JP); Yukihiko Oashi, Kawasaki (JP); Shizuo Ishijima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/320,496

(22) Filed: Jan. 27, 2009

(30) Foreign Application Priority Data
May 26, 2008 (JP) 2008-137150

(51) Int. Cl. B23K 31/02; B23K 1/018

(52) U.S. Cl. 228/119; 228/264

(57) ABSTRACT

A method is disclosed for performing rework soldering for removing an electronic component from a printed circuit board and re-soldering the electronic component to the printed circuit board. The method includes the steps of positioning a dual structure body including a heating member and a cooling member between a rework target and a non-rework target placed on the printed circuit board, the heating member and the cooling member being arranged facing each other with a slight space provided therebetween, the heating member being situated toward the rework target, the cooling member being situated toward the non-rework target; heating the heating member; and cooling the cooling member.

### CROSS-REFERENCE TO RELATED APPLICATIONS

This application is based upon and claims the benefit of priority of the prior Japanese Patent Application No. 2008-137150 filed on May 26, 2008, the entire contents of which are incorporated herein by reference.

### FIELD

The embodiments discussed herein are related to a method and an apparatus for rework soldering. For example, a method and apparatus for performing reflow soldering or rework soldering.

### BACKGROUND

Newly developed high performance LSIs (Large Scale Integrated Circuit) using, for example, BGA (Ball Grid Array) are widely used by communication devices and information devices. Electric connection failure with respect to a printed circuit board on which a BGA electronic component is mounted, is in many cases, found for the first time during a testing phase after the BGA electronic component is mounted on the printed circuit board. Since the printed circuit boards are relatively expensive, a reworking (replacing) operation is performed on the BGA electronic component for resolving the connection failure.

In recent years, lead free solder has been promoted in view of environmental protection. Due to the transition from tin/lead eutectic solder to lead free solder, it is becoming difficult to perform rework soldering where solder bumps of a BGA electronic component are thermally melted for reworking. This is because the melting point of lead free solder (for example, approximately 217° C.) is higher than the melting point of tin/lead eutectic solder (approximately 183° C.).

Furthermore, although increase in the size of electronic components and decrease of space between electronic components (e.g., space no greater than 2 mm) are progressing due to demands for more functions to be provided by an electronic apparatus, improvement of heat resistance of the electronic apparatus is unlikely. Therefore, controlling the temperature at spaces between electronic components is one important aspect. In one example of controlling the temperature in a rework soldering process, the temperature of the electronic component to be replaced is set to be no less than the minimum soldering temperature (e.g., 230° C.) and the temperature of the component (peripheral component) which is not to be replaced is set to be no greater than the heat resistance temperature (e.g., 170° C.) of the peripheral component.

FIG. 1 illustrates a side view of a rework soldering apparatus according to a related art example. In FIG. 1, an electronic component (rework target) 1 and bumps 1a of the electronic component 1 are heated by blowing warm air from a warm air nozzle 2 positioned above the electronic component 1 (see arrows in FIG. 1). Further, the bumps 1a are also heated via a printed circuit board 3 by blowing warm air from a warm air nozzle 4 positioned below a lower surface of the printed circuit board 3 on which the electronic component 1 is provided.

A heat insulating material 6 is arranged between the electronic component 1 and another neighboring electronic component (peripheral component) 5 which is not subject to the reworking process, so that the warm air from the warm air nozzle 2 does not blow upon the peripheral component 5. Further, a heat absorbing material 7 is placed into contact with the peripheral component 5 to prevent the temperatures of the peripheral component 5 and bumps 5a of the peripheral component 5 from increasing.

For example, Japanese Laid-Open Patent Publication No. 2003-188527 discloses a method of heating a lower surface of a substrate having an electronic component mounted on an upper surface of the substrate and compulsorily cooling the upper surface with cool air. As another example, Japanese Laid-Open Patent Publication No. 61-56769 discloses a method of arranging thermal insulating materials between a pre-heating part, a main heating part, and a cooling part of a reflow furnace and thermally separating these parts from each other.

As the space between the electronic component 1 and the peripheral component 5 is further reduced for achieving high density mounting, the radiant heat and the convective heat of the atmosphere and the heat conducted from the printed circuit board 3 may cause the temperature of the bumps 5a facing the electronic component 1 to surpass the heat resistance temperature of 170° C. when the bumps 1a facing the peripheral component 5 are heated to a temperature of 230° C.

Further, enhancing the heat absorbing performance by cooling the heat absorbing material 7 with a cooling agent (e.g., dry ice) and compulsorily reducing the temperature of the bumps 5a facing the electronic component 1 may cause the temperature of the bumps 1a facing the peripheral component 5 to decrease and degrade solder joining of the bumps 1a.

### SUMMARY

According to an aspect of the invention, a method for performing rework soldering for removing an electronic component from a printed circuit board and re-soldering the electronic component to the printed circuit board includes the steps of: positioning a dual structure body including a planar heating member and a cooling member between a rework target and a non-rework target placed on the printed circuit board, the heating member and the cooling member being arranged facing each other with a slight space provided therebetween, the heating member being situated toward the rework target, the cooling member being situated toward the non-rework target; heating the heating member; and cooling the cooling member.

According to another aspect of the invention, an apparatus for performing rework soldering for removing an electronic component from a printed circuit board and re-soldering the electronic component to the printed circuit board includes: a dual structure body including a planar heating member and a cooling member positioned between a rework target and a non-rework target placed on the printed circuit board, the heating member and the cooling member being arranged facing each other with a slight space provided therebetween, the heating member being situated toward the rework target, the cooling member being situated toward the non-rework target.

The object and advantages of the invention will be realized and attained by means of the elements and combinations particularly pointed out in the claims.

It is to be understood that both the foregoing generation description and the followed detailed description are exemplary and explanatory and are not restrictive of the invention, as claimed.

### BRIEF DESCRIPTION OF DRAWINGS

FIG. 1 illustrates a side view of a rework soldering apparatus according to a related art example;

FIG. 2 is a side view for describing an overall configuration of a rework soldering apparatus according to an embodiment of the present invention;

FIG. 3 is a side view illustrating an embodiment of a rework soldering apparatus;

FIG. 4 is a cross-sectional view illustrating a part of an embodiment of a rework soldering apparatus;

FIG. 5 is a perspective view illustrating an embodiment of a heating/reflecting plate;

FIG. 6 is a perspective view illustrating an embodiment of a cooling plate;

FIG. 7 is a perspective view illustrating a first embodiment of a dual structure body;

FIG. 8 is a perspective view illustrating a second embodiment of a dual structure body; and

FIG. 9 is a table for describing effects of an embodiment of the present invention.

### DESCRIPTION OF EMBODIMENTS

In the following, embodiments of the present invention will be described with reference to the accompanying drawings.

With the below-described embodiments of the present invention, for example, reflow soldering or rework soldering of an electronic component(s) by using lead free solder can be realized.

### <Overall Configuration of Rework Soldering Apparatus>

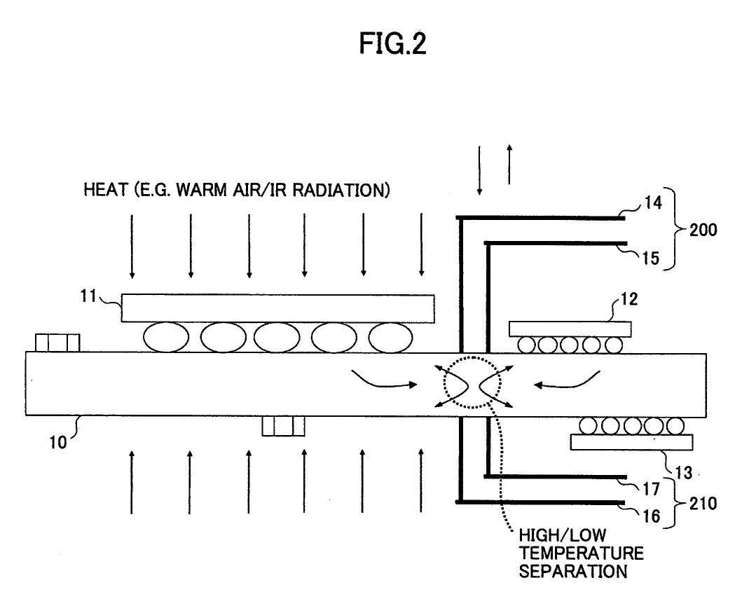

FIG. 2 is a side view for describing an overall configuration of a rework soldering apparatus according to an embodiment of the present invention. In FIG. 2, a BGA electronic component (a component subject to a rework/soldering process, hereinafter also referred to as “rework target”) 11 and a first BGA peripheral component (a component not subject to a rework/soldering process, hereinafter also referred to as “non-rework target”) 12 are positioned on an upper surface of a printed circuit board 10. A second BGA peripheral component (non-rework target) 13 is positioned on a lower surface of the printed circuit board 10.

The electronic component 11 can be selectively (partially) heated from both sides of the printed circuit board 10 by, for example, warm air, infrared (IR) rays, or a heating head.

On the upper surface of the printed circuit board 10, a first dual structure 200 is positioned between a heating area for heating the electronic component 11 and a cooling area for cooling the first peripheral component 12 and has an end part contacting the upper surface of the printed circuit board 10. The first dual structure 200 includes a first heating/reflecting plate (heating member) 14 and a first cooling plate (cooling member) 15 that are arranged facing each other with a slight space provided therebetween. On the lower surface of the printed circuit board 10, a second dual structure 210 is positioned between the heating area for heating the electronic component 11 and a cooling area for cooling the second peripheral component 13 and has an end part contacting the lower surface of the printed circuit board 10. The second dual structure 210 includes a second heating/reflecting plate (heating member) 16 and a second cooling plate (cooling member) 17 that are arranged facing each other with a slight space provided therebetween.

The first and second heating/reflecting plates 14, 16 are not only configured to heat themselves but also reflect convective heat/radiant heat from the heating area. The first and second cooling plates 15, 17 are configured to cool themselves. By providing a space (filled with atmospheric air having low thermal conductivity) between the first heating/reflecting plate 14 and the first cooling plate 15, the first heating/reflecting plate 14 and the first cooling plate 15 can be thermally separated from each other. Likewise, by providing a space (filled with atmospheric air having low thermal conductivity) between the second heating/reflecting plate 16 and the second cooling plate 17, the second heating/reflecting plate 16 and the second cooling plate 17 can be thermally separated from each other.

By providing the dual structures in a manner having end parts of the first and second heating reflecting plates 14, 16 and end parts of the first and second cooling plates 15, 17 contacting the printed circuit board 10, convective heat and radiant heat from the atmosphere and thermal conduction from the printed circuit board 10 can be effectively controlled.

### <Embodiment of Rework Soldering Apparatus>

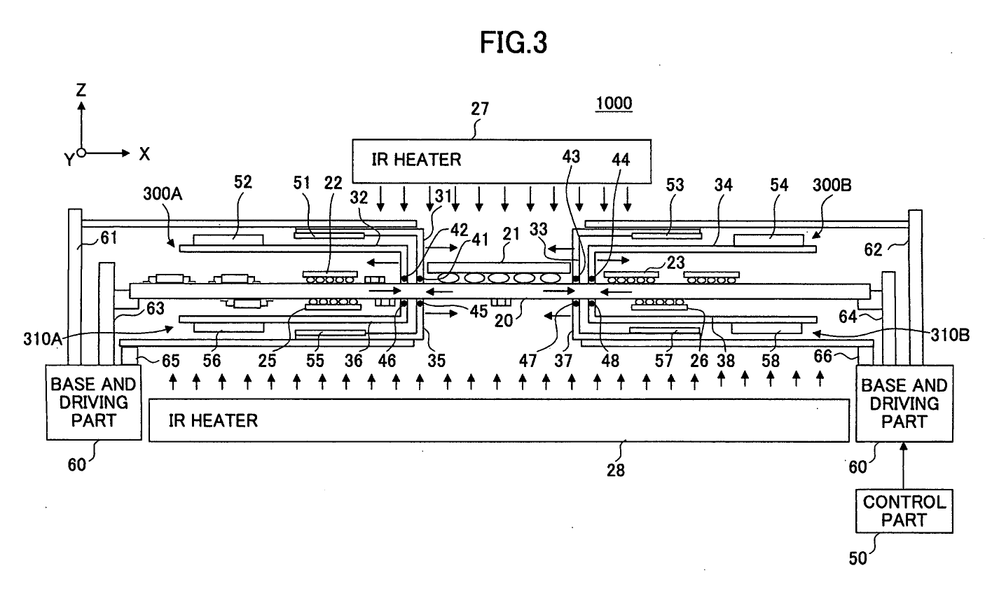

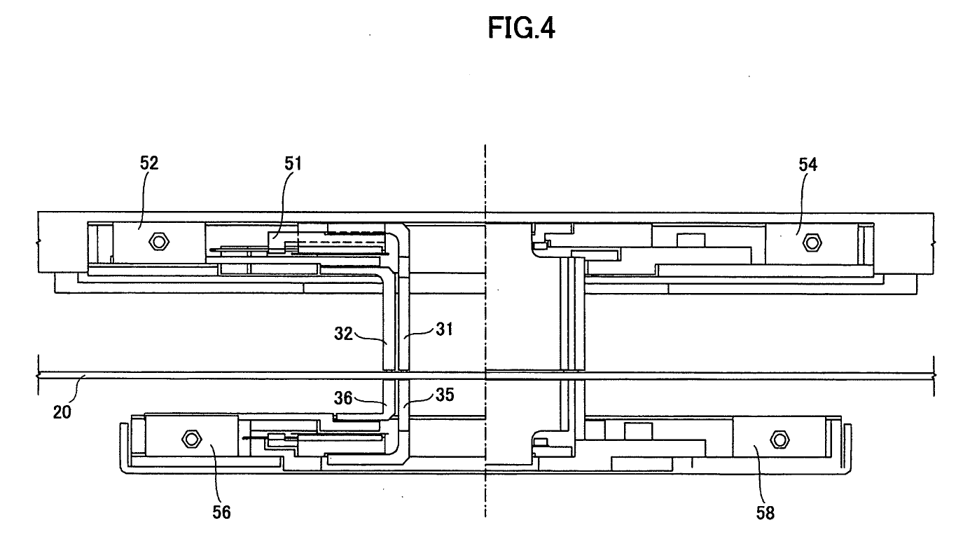

FIG. 3 is a side view illustrating an embodiment of a rework soldering apparatus 1000. FIG. 4 is a cross-sectional view illustrating a part of the embodiment of the rework soldering apparatus 1000 of FIG. 3. In FIGS. 3 and 4, a BGA electronic component (rework target) 21, BGA peripheral components (non-rework targets) 22, 23, and other components are provided on an upper surface of a printed circuit board 20, and BGA peripheral components (non-rework targets) 25, 26 and other components are provided on a lower surface of the printed circuit board 20.

The electronic component 21 is partially heated by an infrared heater 27 from an upper side of the printed circuit board 20 and is entirely heated by another infrared heater 28 from a lower side of the printed circuit board 20.

A dual structure body 300A is provided on the upper surface of the printed circuit board 20. The dual structure body 300A includes a heating/reflecting plate (heating member) 31 and a cooling plate (cooling member) 32 facing each other with a slight space provided therebetween. The dual structure body 300A has end parts contacting the upper surface of the printed circuit board 20 between a heating area for heating the electronic component 21 and a cooling area for heating the peripheral component 22. A dual structure body 300B is provided on the upper surface of the printed circuit board 20. The dual structure body 300B includes a heating/reflecting plate (heating member) 33 and a cooling plate (cooling member) 34 facing each other with a slight space provided therebetween. The dual structure body 300B has end parts contacting the upper surface of the printed circuit board 20 between a heating area for heating the electronic component 21 and a cooling area for cooling the peripheral component 23.

Further, a dual structure body 310A is provided on the lower surface of the printed circuit board 20. The dual structure body 310A includes a heating/reflecting plate (heating member) 35 and a cooling plate (cooling member) 36 facing each other with a slight space provided therebetween. The dual structure body 310A has end parts contacting the lower surface of the printed circuit board 20 between a heating area for heating the electronic component 21 and a cooling area for cooling the peripheral component 25. A dual structure body 310B is provided on the lower surface of the printed circuit board 20. The dual structure body 310B includes a heating/reflecting plate (heating member) 37 and a cooling plate (cooling member) 38 facing each other with a slight space provided therebetween. The dual structure body 310B has end parts contacting the lower surface of the printed circuit board 20 between a heating area for heating the electronic component 21 and a cooling area for cooling the peripheral component 26. With the dual structure bodies 300A, 300B, 310A, 310B, the spaces between the heating/reflecting plates 31, 33, 35, 37 and the cooling plates 32, 34, 36, 38 are filled with atmospheric air having low heat conductivity.

Each of the heating/reflecting plates 31, 33, 35, 37 has one end part contacting the surface of the printed circuit board 20. Temperature sensors 41, 43, 45, 47 are provided at the vicinity of corresponding end parts of the heating/reflecting plates 31, 33, 35, 37. Likewise, each of the cooling plates 32, 34, 36, 38 has one end part contacting the surface of the printed circuit board 20. Temperature sensors 42, 44, 46, 48 are provided at the vicinity of corresponding end parts of the cooling plates 32, 34, 36, 38. The temperatures detected by the temperature sensors 41-48 are supplied to a control part 50.

Heating parts (e.g., panel heaters) 51, 53, 55, 57 are provided at the other end parts (distal end parts positioned apart from the surface of the printed circuit board 20) of the heating/reflecting plates 31, 33, 35, 37. Further, cooling parts (e.g., heat releasing fins) 52, 54, 56, 58 are provided at the other end parts (distal end parts positioned apart from the surface of the printed circuit board 20) of the cooling plates 32, 34, 36, 38.

The control part 50 controls the temperatures of the heating parts 51, 53, 55, 57 separately so that each of the temperatures of the heating/reflecting plates 31, 33, 35, 37 detected by the temperature sensors 41, 43, 45, 47 becomes a predetermined temperature (e.g., no less than 230° C.). Further, the control part 50 controls the temperatures of the cooling parts 52, 54, 56, 58 separately so that the temperatures of the cooling plates 32, 34, 36, 38 detected by the temperature sensors 42, 44, 46, 48 become a predetermined temperature (e.g., no greater than 170° C.). It is to be noted that, in a case where heat releasing fins are used as the cooling parts 52, 54, 56, 58, the control part 50 controls the temperatures of the cooling parts 52, 54, 56, 58 by controlling the amount of refrigerant (e.g., air, water) to be supplied to the heat releasing fins.

Alternatively, one temperature sensor can be provided on each surface (upper surface and lower surface) of the printed circuit board 20 instead providing all of the temperature sensors 41-48 in the vicinity of the upper and lower surfaces of the printed circuit board 20, to allow the control part 50 to control the temperatures of the heating parts 51, 53, 55, 57 and the cooling parts 52, 54, 56, 58 based on the temperatures detected by the temperature sensor provided on each surface of the printed circuit board 20.

A base/driving part 60, which serves as a base and a driving part, includes supporting members 61-66. The supporting member 61 supports the heating/reflecting plate 31 and the cooling plate 32. The control part 50 drives the supporting member 61 to move (change position) in direction Z (thickness direction of the printed circuit board 20), direction X (horizontal direction in FIG. 3), or direction Y (depth direction in FIG. 3), to enable the end parts of the heating/reflecting plate 31 and the cooling plate 32 to contact the printed circuit board 20.

The supporting member 62 supports the heating/reflecting plate 33 and the cooling plate 34. The control part 50 drives the supporting member 62 to move (change position) in direction Z, direction X, or direction Y, to enable the end parts of the heating/reflecting plate 33 and the cooling plate 34 to contact the printed circuit board 20.

The supporting members 63, 64 support the printed circuit board 20. The control part 50 drives the printed circuit board 20 to move (change position) in direction Z, direction X, or direction Y and drives the printed circuit board 20 to rotate around the Z axis of the printed circuit board 20. Accordingly, flexibility during selection of the electronic component 21 can be improved.

The supporting member 65 supports the heating/reflecting plate 35 and the cooling plate 36. The control part 50 drives the supporting member 62 to move (change position) in direction Z, direction X, or direction Y, to enable the end parts of the heating/reflecting plate 35 and the cooling plate 36 to contact the part of the printed circuit board 20 between the electronic component 21 and the peripheral component 25.

The supporting member 66 supports the heating/reflecting plate 37 and the cooling plate 38. The control part 50 drives the supporting member 66 to move (change position) in direction Z, direction X, or direction Y, to enable the end parts of the heating/reflecting plate 37 and the cooling plate 38 to contact the part of the printed circuit board 20 between the electronic component 21 and the peripheral component 26.

As illustrated in FIG. 3, bending of the printed circuit board 20 can be prevented because the printed circuit board 20 is in a fixed position by having its upper and lower surfaces held (sandwiched) by the end parts of the heating/reflecting plates 31, 33, 35, 37 and the end parts of the cooling plates 32, 34, 36, 38.

### <Structure of Heating/Reflecting Plate>

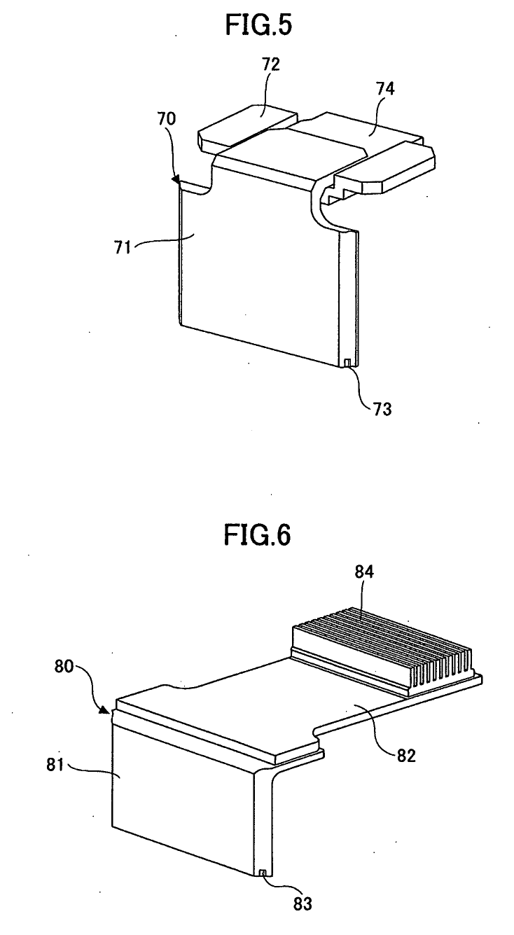

FIG. 5 is a perspective view illustrating an embodiment of a heating/reflecting plate 70 (corresponding to the heating/reflecting plate 31, 33, 35, 37). In FIG. 5, the heating/reflecting plate 70 includes a metal heating plate 71 and a heating plate holding member 72. For example, a copper plate having high thermal conductivity (403 W/m·k) and a thickness of approximately 3 mm may be used as the metal heating plate 71. Further, surface treating using, for example, gold plating may be performed on the metal heating plate 71 for restraining heat radiation and heat absorption of the metal heating plate 71, to control the radiant heat with respect to, for example, a metal cooling plate 81 (described below) to be a minimum amount. Alternatively, other than using copper for the metal heating plate 71, aluminum, iron, or stainless steel may also be used.

A buffering member (shock absorbing member) 73 is provided at an end portion of the metal heating plate 71 contacting the printed circuit board 20. A resin material having heat resistance and high thermal conductivity or a metal leaf spring may be used as the buffering member 73. Thus, by having the metal heating plate 71 in firm contact with the printed circuit board 20 with the buffering member 73, heat flow can be effectively controlled (e.g., effectively separated) and the printed circuit board 20 can be prevented from being damaged.

The metal heating plate 71 is supported by the heating plate holding member 72. The heating plate holding member 72 is supported by the supporting members 61-66 of the base/driving part 60. The heating parts 51, 53, 55, 57 are attached to a center part 74 of the heating plate holding member 72 for heating the metal heating plate 71. It is to be noted that, the metal heating plate 71 and the heating plate holding member 72 may be formed as a united body (integrally formed) and a heat pipe may be used to heat the united body.

### <Structure of Cooling Plate>

FIG. 6 is a perspective view illustrating an embodiment of a cooling plate 80 (corresponding to the cooling plates 32, 34, 36, 38). In FIG. 6, the cooling plate 80 includes a metal cooling plate 81 and a cooling plate holding member 82. For example, a copper plate having a high thermal conductivity (403 W/m·k) and a thickness of approximately 3 mm may be used as the metal cooling plate 81. Further, surface treating using, for example, gold plating may be performed on the metal cooling plate 81 for restraining heat radiation to and heat absorption by the metal cooling plate 81, to thereby control the radiant heat absorbed with respect to, for example, the metal heating plate 71 to be a minimum amount. Alternatively, other than using copper for the metal cooling plate 81, aluminum, iron, or stainless steel may also be used.

A buffering member (shock absorbing member) 83 is provided at an end portion of the metal cooling plate 81 contacting the printed circuit board 20. A resin material having heat resistance and high thermal conductivity or a metal leaf spring may be used as the buffering member 83. Thus, by having the end portion of the metal cooling plate 81 in firm contact with the printed circuit board 20 with the buffering member 83, heat flow can be effectively controlled (e.g., effectively separated) and the printed circuit board 20 can be prevented from being damaged.

The metal cooling plate 81 is supported by the cooling plate holding member 82. The cooling plate holding member 82 is supported by the supporting members 61-66 of the base/driving part 60. A cooling part (corresponding to the cooling part 52, 54, 56, 58) is attached to the cooling plate holding member 82 for cooling the metal cooling plate 81. It is to be noted that, the metal cooling plate 81 and the cooling plate holding member 82 may be formed as a united body (integrally formed) and a heat pipe may be used to cool the united body.

### <First Embodiment of Dual Structure Body>

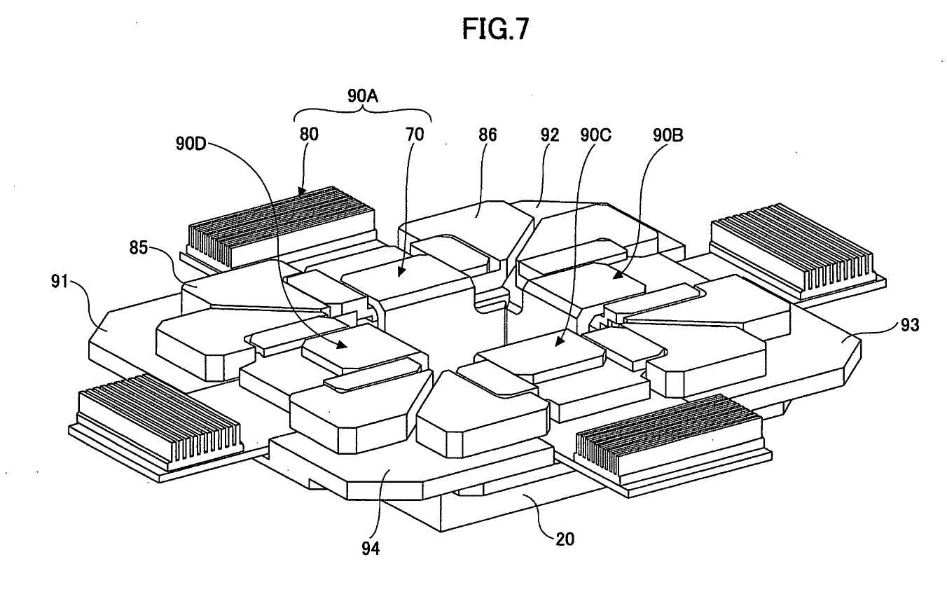

FIG. 7 is a perspective view for describing a first embodiment of a dual structure body having the heating/reflecting plate 70 of FIG. 5 and the cooling plate 80 of FIG. 6 assembled together. FIG. 7 illustrates a dual structure body 90A having the heating/reflecting plate 70 and the cooling plate 80 supported and fixed to each other by supporting members 91, 92 in a manner where the supporting members 91, 92 are interposed between the heating/reflecting plate 70 and the cooling plate 80. The supporting members 91, 92 are formed of a heat insulating material such as ceramic. By positioning the heating/reflecting plate 70 and the cooling plate 80 in a manner facing each other and having a slight space (e.g., 1 mm) provided between the heating/reflecting plate 70 and the cooling plate 80, an air layer, which acts as a thermal insulating material, can be formed between the heating/reflecting plate 70 and the cooling plate 80.

In FIG. 7, the dual structure body 90A and dual structure bodies 90B-90D formed in the same manner as the dual structure body 90A are arranged in a manner surrounding the four sides of the electronic component (rework target) 21 provided on the upper surface of the printed circuit board 20 via the supporting members 91, 92 and supporting members 93, 94 formed in the same manner as the supporting members 91, 92.

Accordingly, thermal conductance from the printed circuit board 20 can be restrained (controlled) at an area between the electronic component 21 and the peripheral components 22, 23, 25, 26, to thermally separate the electronic component 21 and the peripheral components 22, 23, 25, 26 provided on the printed circuit board 20.

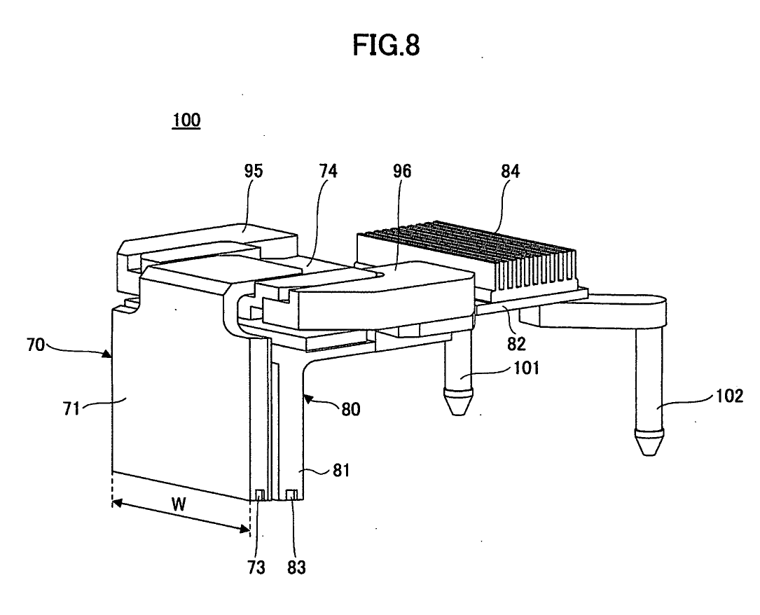

FIG. 8 is a perspective view for describing a second embodiment of a dual structure body having the heating/reflecting plate 70 of FIG. 5 and the cooling plate 80 of FIG. 6 assembled together. FIG. 8 illustrates a dual structure body 100 having the heating/reflecting plate 70 and the cooling plate 80 supported by and fixed to each other by supporting members 95, 96 in a manner where the supporting members 95, 96 are interposed between the heating/reflecting plate 70 and the cooling plate 80. The supporting members 91, 92 are formed of a heat insulating material such as ceramic. By positioning the heating/reflecting plate 70 and the cooling plate 80 in a manner facing each other and having a slight space (e.g., 1 mm) provided between the heating/reflecting plate 70 and the cooling plate 80, an air layer, which acts as a thermal insulating material, can be formed between the heating/reflecting plate 70 and the cooling plate 80.

Supporting leg members 101, 102 are fixed to the cooling plate 80 at an end part of the cooling plate holding member 82 substantially opposite from the metal cooling plate 81. The supporting leg members 101, 102 together with an end part of the metal heating plate 71 and an end part of the metal cooling plate 81 abut against the printed circuit board 20, to allow the dual structure body 100 to maintain a predetermined position.

By preparing various dual structure bodies 100 having different widths W between the heating/reflecting plate 70 and the cooling plate 80, the dual structure body 100 can be selected in accordance with the length and width of the electronic component 21 (rework target).

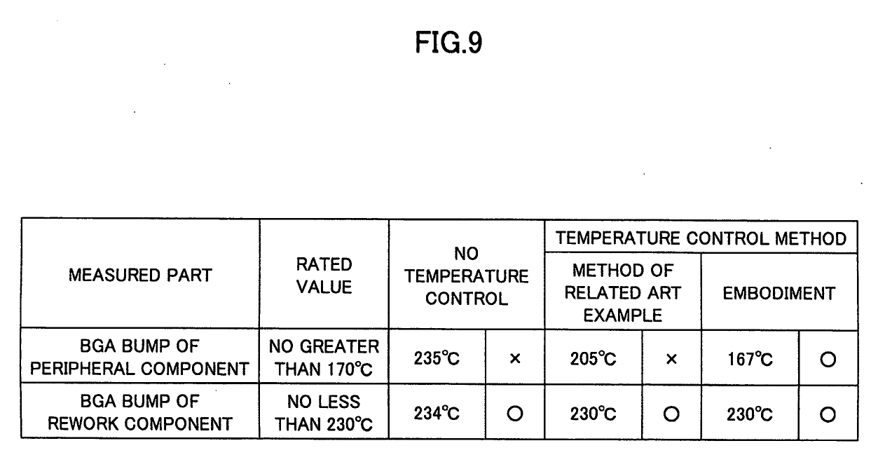

As illustrated in FIG. 9, in a case of performing rework soldering, the rated value of the minimum temperature for joining the bumps of the electronic component 21 is no less than 230° C., and the rated value of the heat resistance temperature of the bumps of, for example, the peripheral components 22, 23 is no greater than 170° C.

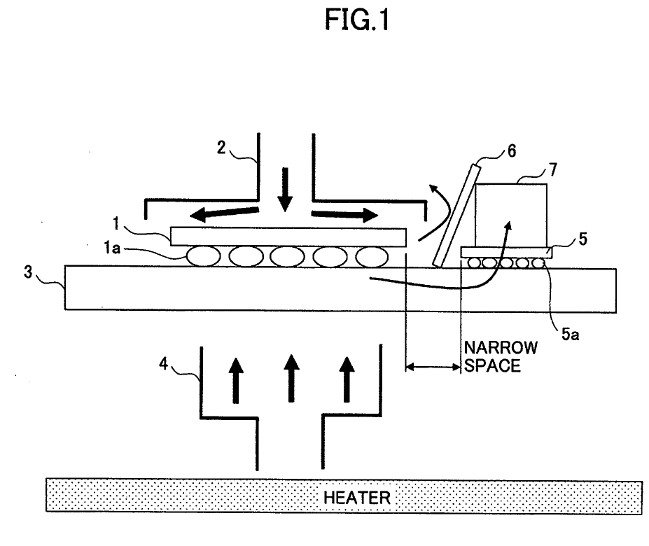

In a case of performing no temperature control and heating the electronic component 21 and the peripheral components 22, 23 simply with the infrared heaters 27, 28, the temperature of the bumps of the electronic component 21 becomes 234° C. and the temperature of the bumps of the peripheral component 22 becomes 235° C. Thus, the temperature of the bumps of the peripheral component 22 surpasses the rated value of 170° C. Further, in a case of using a related art method described with FIG. 1, the temperature of the bumps of the electronic component 21 becomes 230° C. and the temperature of the bumps of the peripheral component 22 becomes 205° C. Thus, the temperature of the bumps of the peripheral component 22 surpasses the rated value of 170° C.

In a case of using the embodiment described with FIG. 3, the temperature of the bumps of the electronic component 21 becomes 230° C. and the temperature of the bumps of the peripheral component 22 becomes 167° C. Thus, both the temperatures of the bumps of the electronic component 21 and the bumps of the peripheral component 22 satisfy the rated values.

According to the above-described embodiments, by using a dual structure body having a heating/reflecting plate and a cooling plate arranged facing each other with a slight space provided therebetween, the heating/reflecting plate and the cooling plate can be mounted in a narrow space(s) between an electronic component and a peripheral component of a printed circuit board. Further, a rework soldering apparatus can be manufactured at a low cost because the dual structure body has a simple configuration. Further, with the dual structure body, lead free soldering of a printed circuit board can be achieved and components can be mounted on a printed circuit board at high density.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A method for performing rework soldering for replacing an electronic component from a printed circuit board and re-soldering the electronic component to the printed circuit board, the method comprising the steps of:
positioning a dual structure body including a heating member and a cooling member between a rework target and a non-rework target placed on the printed circuit board, the heating member and the cooling member being arranged facing each other with a slight space provided therebetween, the heating member being situated towards the rework target, the cooling member being situated towards the non-rework target;
heating the heating member; and
cooling the cooling member.

2. The method as claimed in claim 1, further comprising:
using a metal material having high thermal conductivity as the heating member and the cooling member.

3. The method as claimed in claim 1, further comprising:
preventing heat radiation and heat absorbance of the heating member and the cooling member by surface treating the heating member and the cooling member.

4. The method as claimed in claim 1, further comprising:
forming a buffering member on an end part of the heating member and an end part of the cooling member that contact the printed circuit board.

5. The method as claimed in claim 1, further comprising:
placing the dual structure on a front surface of the printed circuit board and another dual structure on a back surface of the circuit board.

6. The method as claimed in claim 1, further comprising:
providing a temperature sensor on at least one of the heating member and the cooling member; and
controlling the temperatures of the heating member and the cooling member according to the temperature detected by the temperature sensor.

7. An apparatus for performing rework soldering for replacing an electronic component from a printed circuit board and re-soldering the electronic component to the printed circuit board, the apparatus comprising:
a dual structure body including a heating member and a cooling member positioned between a rework target and a non-rework target placed on the printed circuit board, the heating member and the cooling member being arranged facing each other with a slight space provided therebetween, the heating member being situated towards the rework target, the cooling member being situated towards the non-rework target.

8. The apparatus as claimed in claim 7, wherein the heating member and the cooling member are formed of a metal material having high thermal conductivity.

9. The apparatus as claimed in claim 7, wherein the heating member and the cooling member are surface treated for preventing heat radiation and heat absorbance of the heating member and the cooling member.

10. The apparatus as claimed in claim 7,
wherein the heating member and the cooling member each has an end part contacting the printed circuit board, wherein a buffering member is formed on each end part of the heating member and the cooling member.

11. The apparatus as claimed in claim 7, further comprising:
another dual structure body;
wherein the dual structure is placed on a front surface of the printed circuit board and the other dual structure is placed on a back surface of the printed circuit board.

12. The apparatus as claimed in claim 7, further comprising:
a temperature sensor provided on at least one of the heating member and the cooling member; and
a control part configured to control the temperatures of the heating member and the cooling member according to the temperature detected by the temperature sensor.
